(19) United States
(12) Patent Application Publication
(10) Pub. No.: US 2025/0140485 A1
(43) Pub. Date: May 1, 2025

(54) A SUPERCAPACITOR COMPRISING A SEPARATOR WITH A PERMANENT ELECTRICAL DIPOLE

(71) Applicant: University of Surrey, Guildford Surrey (GB)

(72) Inventors: Wesley BUXTON, Cambridge (GB); Vlad STOLOJAN, Cliddesden (GB)

(73) Assignee: University of Surrey, Guildford Surrey (GB)

(21) Appl. No.: 18/683,956

(22) PCT Filed: Aug. 11, 2022
(86) PCT No.: PCT/GB2022/052097

§ 371 Date: Feb. 15, 2024

(30) Foreign Application Priority Data
Aug. 16, 2021 (GB) 2111736.1

(51) Int. Cl. H01G 11/52; H01G 9/02; H01G 11/04; H01G 11/84

(52) U.S. Cl. CPC H01G 11/52; H01G 9/02; H01G 11/04; H01G 11/84

(57) ABSTRACT

A supercapacitor is disclosed, comprising a first electrode, a second electrode, and a separator disposed between the first and second electrodes. The separator comprises a permanent electrical dipole, and is arranged such that the permanent electrical dipole is oriented so as to present an energy barrier to inhibit a self-discharge diffusion of ions stored on the first and second electrodes while the supercapacitor is in a charged state. In some embodiments the separator comprises a nanofibre film, which may for example be formed by electrospinning. A method of fabricating the supercapacitor is also disclosed.

### TECHNICAL FIELD

The present invention relates to a supercapacitor comprising a separator. More particularly, the present invention relates to a supercapacitor comprising a separator with a permanent electrical dipole.

### BACKGROUND

Supercapacitors are a developing technology which have potential to replace or supplement conventional power sources for electrical devices, such as mobile electrical devices. With faster charging times than conventional lithium batteries, higher power density and competing energy density, supercapacitors have many advantages that could benefit applications such as electric vehicles or mobile phones.

Supercapacitors comprise two electrodes, which are separated by a separator and an electrolyte. During charging, cations are stored on the negatively charged electrode and anions are stored on the positively charged electrode. When the external power supply charging the supercapacitor is removed, a concentration gradient exists across the supercapacitor which encourages the diffusion of the accumulated charge carriers away from the respective electrodes. This phenomenon is commonly referred to as ‘self discharging’, and is a known issue with current supercapacitors. The phenomenon results in a reduced energy storage efficiency over extended periods of time. This is detrimental when using supercapacitors in applications where the device may be sat idle for extended periods of time. Accordingly, there is therefore a need in the art for an improved supercapacitor that is less susceptible to self-discharge.

### SUMMARY OF THE INVENTION

According to a first aspect of the present invention, there is provided a supercapacitor comprising: a first electrode; a second electrode; a separator disposed between the first and second electrodes, the separator comprising a permanent electrical dipole, wherein the separator is arranged such that the permanent electrical dipole is oriented so as to present an energy barrier to inhibit a self-discharge diffusion of ions stored on the first and second electrodes while the supercapacitor is in a charged state.

In some embodiments according to the first aspect, the first and second electrodes comprise carbon.

In some embodiments according to the first aspect, the mass of the second electrode is larger than the mass of the first electrode.

In some embodiments according to the first aspect, the separator comprises a nanofibre film comprising a plurality of nanofibres. In some embodiments the plurality of nanofibres are randomly oriented. In other embodiments, the plurality of nanofibres are aligned.

In some embodiments according to the first aspect, the plurality of nanofibres have a mean diameter of less than or equal to 600 nm. In some embodiments according to the first aspect, the plurality of nanofibers have a mean diameter of more than or equal to 50 nm. In some embodiments according to the first aspect, a mean pore size of the nanofiber film is less than 1 μm.

In some embodiments according to the first aspect, the separator comprises polyvinylidene fluoride, PVDF.

In some embodiments according to the first aspect, the separator comprises a surfactant. For example, in some embodiments the surfactant comprises sodium dodecyl sulphate, SDS. A percentage by mass concentration of SDS in the separator may be less than or equal to 10%, and/or may be greater than or equal to 5%. In some embodiments according to the first aspect, the separator is formed from a precursor solution with a concentration by mass of SDS of between about 1% and about 2%.

According to a second aspect of the present invention, there is provided a method of fabricating a supercapacitor comprising a first electrode, a second electrode and a separator, the separator comprising a permanent electrical dipole, the method comprising disposing the separator between the first and second electrodes such that the permanent electrical dipole is oriented so as to present an energy barrier to inhibit a self-discharge diffusion of ions stored on the first and second electrodes while the supercapacitor is in a charged state.

In some embodiments according to the second aspect, the method comprises processing a separator material without a permanent electrical dipole so as to polarise the separator material to induce the permanent electrical dipole.

In some embodiments according to the second aspect, processing the separator material comprises applying an electric field so as to polarise the separator material to induce the permanent electrical dipole.

In some embodiments according to the second aspect, the electric field is applied in a direction to polarise the separator material to induce the permanent electrical dipole in said direction.

In some embodiments according to the second aspect, processing the separator material comprises heating the separator material to a temperature sufficient to at least partially melt the separator material.

In some embodiments according to the second aspect, the separate material comprises a polymer, and processing the separator material comprises stretching the polymer so as to polarise the separator material to induce the permanent electrical dipole.

In some embodiments according to the second aspect, processing the separator material comprises incorporating a filler material that polarises the separator material to induce the permanent electrical dipole.

In some embodiments according to the second aspect, the method comprises fabricating the separator from the polarised separator material.

In some embodiments according to the second aspect, the method comprises fabricating the separator from the separator material without a permanent electrical dipole, prior to processing the separator material to induce the permanent electrical dipole.

In some embodiments according to the second aspect, the method comprises fabricating the separator by electrospinning a precursor solution of a separator material to produce a polarised nanofiber film with a permanent electrical dipole.

In some embodiments according to the second aspect, the precursor solution of the separator material is electrospun such that a plurality of nanofibers of the nanofiber film are randomly oriented.

In some embodiments according to the second aspect, the precursor solution of the separator material is electrospun such that a plurality of nanofibers of the nanofiber film are aligned.

In some embodiments according to the second aspect, the precursor solution of the separator material is electrospun such that the plurality of nanofibers of the nanofiber film have a mean diameter of less than or equal to 600 nm.

In some embodiments according to the second aspect, the precursor solution of the separator material is electrospun such that the plurality of nanofibers of the nanofiber film have a mean diameter of more than or equal to 50 nm.

In some embodiments according to the second aspect, a mean pore size of the nanofiber film is less than 1 μm.

In some embodiments according to the second aspect, the separator comprises polyvinylidene fluoride, PVDF.

In some embodiments according to the second aspect, the separator comprises a surfactant.

In some embodiments according to the second aspect, the surfactant comprises sodium dodecyl sulphate, SDS.

In some embodiments according to the second aspect, a percentage by mass concentration of SDS in the separator material is less than or equal to 10%.

In some embodiments according to the second aspect, a percentage by mass concentration of SDS in the separator material is more than or equal to 5%.

In some embodiments according to the second aspect, a percentage by mass concentration of SDS in the separator material precursor solution is between about 1% and about 2%.

### BRIEF DESCRIPTION OF THE DRAWINGS

Embodiments of the present invention will now be described, by way of example only, with reference to the accompanying drawings, in which:

FIG. 1 illustrates a schematic cross-section of a supercapacitor comprising a separator with a permanent electrical dipole, according to an embodiment of the present invention;

FIG. 2a illustrates an energy barrier experienced by an anion due to the presence of the separator comprising a permanent electrical dipole in the supercapacitor of FIG. 1;

FIG. 2a illustrates an energy barrier experienced by a cation due to the presence of the separator comprising a permanent electrical dipole in the supercapacitor of FIG. 1;

FIG. 3 illustrates a separator for a supercapacitor comprising a nanofibre film, according to an embodiment of the present invention;

FIG. 4 illustrates an electrospinning process suitable for forming the nanofibre film of FIG. 3, according to an embodiment of the present invention;

FIG. 5a is a graph illustrating the self-discharge behaviour of a supercapacitor comprising a separator with a permanent electrical dipole, according to an embodiment of the present invention;

FIG. 5b is a graph illustrating the self-discharge behaviour of a conventional supercapacitor;

FIG. 6 is a graph comparing the diffusion coefficient of a supercapacitor comprising a separator with a permanent electrical dipole, according to an embodiment of the present invention, to that of a conventional supercapacitor; and

FIG. 7 is a graph comparing the percentage of the starting energy density plotted over time for a supercapacitor comprising a separator with a permanent electrical dipole, according to an embodiment of the present invention, to that of a conventional supercapacitor.

### DETAILED DESCRIPTION

In the following detailed description, only certain exemplary embodiments of the present invention have been shown and described, simply by way of illustration. As those skilled in the art would realise, the described embodiments may be modified in various different ways, all without departing from the scope of the present invention. Accordingly, the drawings and description are to be regarded as illustrative in nature and not restrictive. Like reference numerals designate like elements throughout the specification.

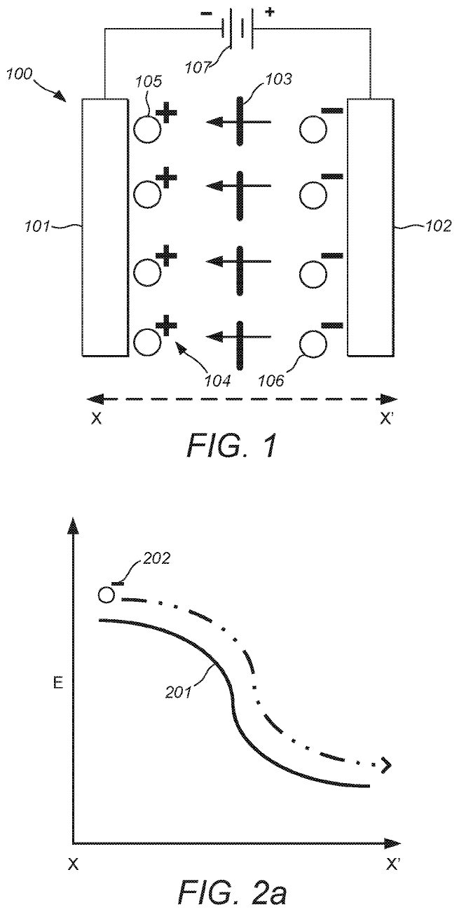

FIG. 1 shows a schematic cross-section of a supercapacitor 100 comprising a first electrode 101, a second electrode 102, a separator 103 and an electrolyte 104, according to an embodiment of the present invention. The first electrode 101 and the second electrode 102 are configured to be electrically connected to an external power supply. When connected to the external power supply 107, an electric field is generated between the negative first electrode 101 and positive second electrode 102. To prevent a short circuit, the separator 103 is disposed between the first and second electrodes, acting as an electrical insulator.

In some embodiments of the present invention, the first and second electrodes may comprise carbon. The carbon can act as a highly conductive material that also has a large surface area to store charge carriers. Additionally, the first and second electrodes may be configured such that the surface area of the second electrode is larger than the surface area of the first electrode. In other words, the positive electrode may have a larger surface area than the negative electrode. The advantage of this is that the supercapacitor is capable of storing a higher amount of charge. It will be appreciated that the size of the ions may differ according to the charge on the ion, and that anions are typically larger than cations. Hence in some embodiments of the invention, for the concentrations of the oppositely-charged ions on the positive and negative electrodes to be equal, the surface area of the positive electrode may be larger than the surface area of the negative electrode to account for the larger size of the anions stored on the positive electrode, compared to the relatively smaller size of the cations stored on the negative electrode.

In some embodiments, the electrodes in any given supercapacitor may comprise different materials, such that the positive and negative electrodes have different compositions. For example, in some embodiments the supercapacitor may incorporate both a carbon electrode and an electrode that is pseudocapacitive.

The separator 103 is in physical contact with the electrolyte 104. The electrolyte 104 comprises a plurality of cations 105 and a plurality of anions 106. The material of the separator 103 is configured to be permeable so as to allow the cations 105 and the anions 106 to pass through the separator during charging and discharging. The material of the separator may have pores that are larger in diameter than the cations 105 and anions 106, so as to allow the cations 105 and anions 106 to move through the separator without significantly affecting their mobility in the electrolyte 104.

The separator 103 further comprises a permanent electrical dipole, such that a permanent electric field is present across the separator 103. The permanent electrical dipole may also be described as a resultant permanent electrical dipole or an oriented permanent electrical dipole. These terms may all be used to refer to a net macroscopic polarisation of the separator.

The permanent electrical dipole is a result of the net cumulative effect of a plurality of electrical dipoles within the material and is shown by the electric field lines, indicated by the arrows pointing from right to left in FIG. 1. The permanent electrical dipole is arranged to be aligned with the direction of travel of the cations 105 and anions 106 as they diffuse between the first and second electrodes 101, 102. In the present embodiment, the permanent electrical dipole is arranged to be in a direction substantially normal to the plane of the separator 103. Since the separator 103 is disposed between the first electrode 101 and second electrode 102 in a plane that is parallel to both the first and second electrodes 101, 102, in this way the permanent electrical dipole is arranged to be aligned with the direction of travel of the cations 105 and anions 106 as they diffuse between the first and second electrodes 101, 102. The advantage of the electrical dipole being normal to the plane of the separator is that it maximises an energy barrier presented to the cations 105 and the anions 106, thereby more effectively inhibiting the diffusion of the cations 105 and the anions 106. However, in other embodiments of the present invention, the permanent electrical dipole may be arranged to be in a direction that is not normal to the plane of the separator. In such embodiments, it will be appreciated that the separator will still present an energy barrier to inhibit the diffusion of the cations 105 and anions 106, albeit to a lesser extent than if the electrical dipole was oriented in the normal direction to the first and second electrodes 101, 102.

The first electrode 101 is arranged to be the negative terminal and the second electrode 102 is arranged to be the positive terminal of the supercapacitor 100. During charging, the cations 105 are attracted to the first electrode 101 and are stored on the first electrode's surface. Conversely, the anions 106 are attracted to the second electrode 102 and are stored on the second electrode's surface. The charging process may be considered complete at the point where there is full electrolyte saturation of the electrode pores, although in practice charging may be terminated before this limit is reached.

The high concentration of cations 105 and anions 106 produce a gradient of ionic charge carrier density. This results in an electrostatic repulsive force exerted on the cations 105 and anions 106 in a direction away from the surface of the electrodes, due to the proximity of similarly charged species at the same electrode. This in turn generates a current, referred to as a self-discharge diffusion current. This is a major contributor to the self-discharge phenomenon, in which a supercapacitor gradually loses charge over a period of time, even in the absence of a load to complete the circuit.

The separator of the present embodiment is configured so as to inhibit the self-discharge phenomenon, as a consequence of the permanent electrical dipole of the separator being arranged such that anions 106 close to the surface of the positive second electrode 102 are electrostatically repelled by the dipoles in the separator 103. Similarly, cations 105 within close proximity to the negative first electrode 101 experience a corresponding effect in the opposite direction. Additionally, the presence of the permanent electrical dipole in the separator 103 causes ions to move rapidly within the pores of the electrodes when charging the supercapacitor, helping to reduce a total charging time required to reach a given level of charge stored on the first and second electrodes 101, 102.

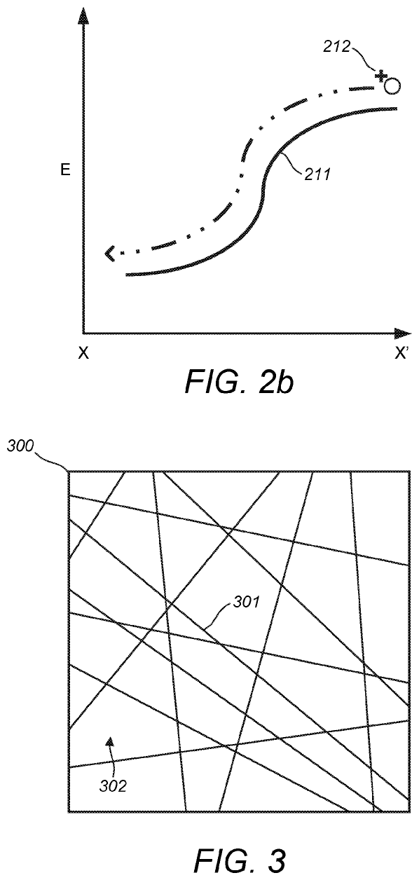

FIGS. 2a and 2b show schematic energy diagrams illustrating the energy barriers experienced by anions and cations, respectively, due to the presence of the separator comprising a permanent electrical dipole in the supercapacitor of FIG. 1. The vertical axis of each diagram denotes the energy level (E) and the horizontal axis represents the distance along the line X-X′ through the cross-section of the supercapacitor 100 shown in FIG. 1, where X is a position in proximity to the first electrode 101 and X′ is a position in proximity to the second electrode 102.

In the present embodiment, the separator 103 is arranged such that the permanent electrical dipole of the material is oriented between the first electrode 101 and second electrode 102 so as to present an energy barrier 201, 211. FIG. 2a illustrates the energy barrier 201 for the anions 202. The energy barrier 201 inhibits anions 202 from moving in a direction from X′ towards X, which is the direction in which the anions 202 would move during self-discharge of the supercapacitor 100. FIG. 2b illustrates the energy barrier 211 for cations 212. The energy barrier 211 inhibits cations 212 from moving in a direction from X towards X′, which is the direction in which the cations 202 would move during self-discharge of the supercapacitor 100.

Resultantly, the interaction between dipoles within the separator 103 structure and ionic charge carriers on the surfaces of the electrodes 101, 102 results in an energy barrier for diffusion-controlled reactions once the device has been charged. This causes the separator 103 to inhibit a self-discharge diffusion of ions stored on the first and second electrodes 101, 102 while the supercapacitor 100 is in a charged state. By configuring the separator 103 in this way, the supercapacitor 100 has a lower electric series resistance, ESR, which in turn allows for faster ionic movement within pores in the separator 103 for efficient charging and discharging, in addition to the advantage of decreasing the rate at which self-discharge occurs.

FIG. 3 illustrates a separator for a supercapacitor comprising a nanofibre film 300, according to an embodiment of the present invention. In this embodiment, the supercapacitor includes a separator comprising a nanofibre film 300 comprising a plurality of nanofibres 301. The nanofibres 301 are layered on top of one another to produce the nanofibre film 300. The plurality of nanofibres 301 may be randomly oriented or aligned in the nanofibre film, depending on the embodiment. The inventors have found that nanofibres with a diameter of more than 600 nm in diameter tend to result in fewer electroactive phases in the nanofibre film. Therefore, the plurality of nanofibres may have a mean diameter of less than or equal to 600 nm. Furthermore, the inventors found that fibres with a diameter of less than 50 nm do not tend to contain high fractions of electroactive phases. Therefore, the plurality of nanofibres may have a mean diameter of more than 50 nm. Accordingly, in some embodiments of the present invention the plurality of nanofibers may have a mean diameter between 50 nm to 600 nm.

The nanofiber film 300 comprises a plurality of pores 302, which are defined by spaces between the nanofibres 301. The plurality of pores 302 are sufficient in size to allow the cations 105 and anions 106 to easily pass through, so as not to have a significant effect on the mobility of cations 105 and anions 106 during charging and discharging. In some embodiments, the nanofibre film 300 may have a mean porosity between 75% and 85%. In other embodiments the nanofibre film used in the separator may have a porosity within a wide range of possible values. For example, in some embodiments of the present invention the separator may have a porosity as low as 35%, or as high as 99.6%, for example in the case of a separator comprising a nanofibre lightweight sponge. In general, increasing the porosity will have the effect of reducing the equivalent series resistance (ESR) of the supercapacitor. Furthermore, as the pore size increases, the risk of the electrodes coming into contact with each other through the pores and creating a short circuit may increase. Accordingly, in some embodiments of the present invention the separator may have a mean pore size of 1 μm or less, to reduce the risk of a short circuit between the electrodes. For example, in some embodiments the separator may comprise a nanofibre film having a mean pore size of 1 ∥m or less.

In some embodiments, the separator 103 comprises a nanofibre film comprising nanofibres formed of polyvinylidene fluoride, PVDF. PVDF based materials have superior properties for supercapacitor separators compared to that of conventional commercial level separators. PVDF can exist in the form of a semi-crystalline polymer made up of five polymorphs of α, β, γ, δ and ε. Both the β and γ phases are polar, allowing them to exhibit piezoelectric properties. The β phase displays the largest electric dipole moment due to the parallel alignment of electronegative Fluorine and electropositive Hydrogen atoms across the entire polymer chain, therefore increasing the proportion of these crystalline phases within the polymer structure and maximising both the polar and piezoelectric properties of the PVDF material. Hence in some embodiments of the present invention, the separator 103 may comprise a nanofibre film comprising nanofibres formed of β-PVDF, thereby providing a strong permanent electrical dipole compared to alternative materials.

In some embodiments of the present invention, the separator may comprise other PVDF based materials including but not limited to the following copolymers of PVDF:
Poly(vinylidene fluoride-co-trifluoroethylene) (PVDF-TRFE)
Poly(vinylidene fluoride-co-hexafluoropropylene) (PVDF-HFP)
Poly(vinylidene fluoride-co-chlorotrifluoroethylene) (PVDF-CTFE)
Poly(vinylidene fluoride-co-bromotrifluoroethylene) (PVDF-BTFE)

Furthermore, in other embodiments of the present invention the separator may comprise materials other than PVDF, including but not limited to the following:
Odd numbered Nylons e.g Nylon 11
Polylactic Acid (PLA)
Cellulose and their derivatives
Polyurethanes (PU)
Polyimides
Polyureas

As previously described, the separator 103 is arranged to be in physical contact with the electrolyte 104. In some embodiments, the separator 103 may comprise a hydrophobic material. The hydrophobic material will tend to repel the electrolyte 104, particularly when an aqueous electrolyte is used. As a result, the electrolyte 104 may not fully saturate the pores 302 of the separator 103, which in turn may inhibit movement of the cations 105 and anions 106 through the separator 103 during charging and discharging.

Accordingly, in some embodiments the present invention, the separator 103 can comprise a surfactant that is configured to convert the separator material from a hydrophobic state to a hydrophilic state, or to enhance an existing hydrophilicity of the separator material. In this way, the addition of the surfactant to the separator 103 can help the separator 103 to effectively absorb the electrolyte 104. This in turn enables faster movement of ionic charge carriers during charging and discharging of the supercapacitor 100, in comparison to a separator formed of the same material but without the surfactant, allowing the supercapacitor 100 to be charged and discharged more quickly. For example, in some embodiments the surfactant may comprise sodium dodecyl sulphate, SDS. High concentrations of sodium dodecyl sulphate (SDS) surfactant in a nanofibre structure not only increases the proportion of polar β phase crystalline phases within a nanofiber but also converts the material from hydrophobic to a highly hydrophilic film, allowing fast movement of electrolyte ions in the charging of aqueous-based supercapacitor devices.

When a surfactant is used, there may be a critical concentration of surfactant at which the transition from hydrophobic to hydrophilic behaviour typically occurs. This critical concentration may be referred to as the percolation threshold. For SDS, the percolation threshold may typically occur at around 1% to 1.5% concentration in a precursor solution. Accordingly, in some embodiments of the present invention in which SDS is used as the surfactant, the concentration by mass of SDS may be at least about 1% in the precursor solution. A concentration by mass of PVDF in the precursor solution may, for example, be about 22%, although other concentrations may be used in other embodiments. A concentration by mass of SDS in the precursor solution of about 1% may result in a nanofibre film having a concentration by mass of SDS of about 5%. Accordingly, in such embodiments the concentration by mass of SDS in the separator may be at least about 1%, to ensure that the separator is in a hydrophilic state.

Additionally, increasing the concentration of the surfactant further, such as above 2%, can increase the risk of the precursor solution becoming too conductive, potentially causing problems with the electrospinning process. Accordingly, in some embodiments of the present invention in which SDS is used as the surfactant and an electrospinning process is used, the concentration by mass of SDS in the precursor solution may be equal to or less than about 2%, to ensure that the solution can be electrospun effectively. A concentration by mass of SDS in the precursor solution of about 2% may result in a nanofiber film having a concentration by mass of SDS of about 10%. Accordingly, in such embodiments the concentration by mass of SDS in the separator may be less than or equal to about 15%. According to some embodiments the percentage by mass concentration of SDS in the separator may be between about 1% and about 15%. In some embodiments, the percentage by mass concentration of SDS in the separator may be between about 2% and about 10%. In some embodiments the percentage by mass concentration of SDS in the separator may be between about 5% and about 8%.

A supercapacitor 100 such as the one illustrated in FIG. 1 may be fabricated by disposing the separator 103 between the first and second electrodes 101, 102 in such a way that the permanent electrical dipole is oriented so as to present an energy barrier as illustrated in FIGS. 2a and 2b. As explained above, orienting the permanent electrical dipole in this way has the effect of inhibiting a self-discharge diffusion of ions 105, 106 stored on the first and second electrodes 101, 102 while the supercapacitor 100 is in a charged state.

In some embodiments of the present invention, a method of fabricating the supercapacitor 100 may further comprise a step of processing a material of the separator, which initially does not have a permanent electrical dipole, in such a way as to polarise the separator material to induce the permanent electrical dipole. In some embodiments, processing the separator material may comprise applying an electric field so as to polarise the separator material to induce the permanent electrical dipole. For example, the separator material may have piezoelectric or ferroelectric material properties. Applying an electric field to the separator material has the effect of increasing the dipole alignment of domains within the separator material. This may be done in combination with heating the separator material to a temperature sufficient to at least partially melt the separator material. The effect on the separator material is an enhanced overall net dipole of the separator material.

The electric field may be applied in a direction which is chosen so as to polarise the separator material to induce the permanent electrical dipole in a certain direction. For example, the separator may be substantially planar or in the form of a sheet. In this exemplary embodiment, the electric field may be applied in a direction substantially normal to the plane of the separator material, such that the resulting permanent electric dipole manifests in a direction that is also substantially normal to the plane of the separator material.

In some embodiments, processing the separator material may involve using thermal annealing and stretching or applying an electric field or a combination of the two, to polarise the separator material to induce the permanent electrical dipole. Introducing energy in the form of thermal radiation increases the malleability of the separator material. This may improve the ability of the dipoles of the material to align when combined with stretching or applying an electric field or a combination of the two, increasing the net electrical dipole of the separator material.

In some embodiments, processing the separator material may comprise polymer stretching to polarise the separator material to induce and/or enhance the permanent electrical dipole, or may comprise incorporating a filler material so as to polarise the separator material to induce and/or enhance the permanent electrical dipole. In the case of polymer stretching, the stretching induces shear and causes molecules to begin to slide past each other. This sliding action and resulting friction acts to align the molecules in a direction of the stretching force and can lead to re-organisation into crystalline phases, including electroactive ones.

The addition of SDS surfactant can further enhance the electroactive phases within the polymer. This is due to interaction between the CH₂ groups in the polymer chains and the negative charge carried by the surfactant. Other anionic surfactants, for example SDBS, follow the same trend. Cationic surfactants can also be used in some embodiments of the present invention, in which case the interactions occur between the CF₂ groups, and the positive charge carried by the surfactant.

The addition of nucleation agents interact with the polymer chains to enhance the beta phases. Examples of materials that may be added as nucleation agents in embodiments of the present invention include, but are not limited to, carbon materials, various metal oxides (ZNO, TiO₂, CUO), and ceramic fillers (BaTiO₃, PZT, BNT). Also, introducing piezoelectric materials can lead to an enhanced dipole, if the individual dipoles are forced to align permanently. According to some embodiments, the piezoelectric materials may be added in the form of nanoparticles. An advantage of incorporating the piezoelectric material in the form of nanoparticles is that the piezoelectric material has a high surface area compared to other physical forms, increasing the effectiveness of the piezoelectric material as a nucleation agent. Additionally, the small size may allow the nanoparticles to be incorporated more readily into the nanofibers.

In embodiments in which the separator is fabricated from material without a permanent electrical dipole, as described above, the material can be processed so as to induce a permanent electrical dipole. In some such embodiments, the separator material could be fabricated in bulk and then formed into individual separators prior to inducing the permanent electrical dipole, for example by cutting or otherwise forming the non-polarised precursor material into the desired shape and dimensions for the separator. The individual separators could then be processed as described above so as to induce a permanent electrical dipole in the correct orientation. As an alternative to starting with a material that does not have a permanent electrical dipole, in other embodiments of the present invention the separator may be fabricated from a material that is already permanently polarised.

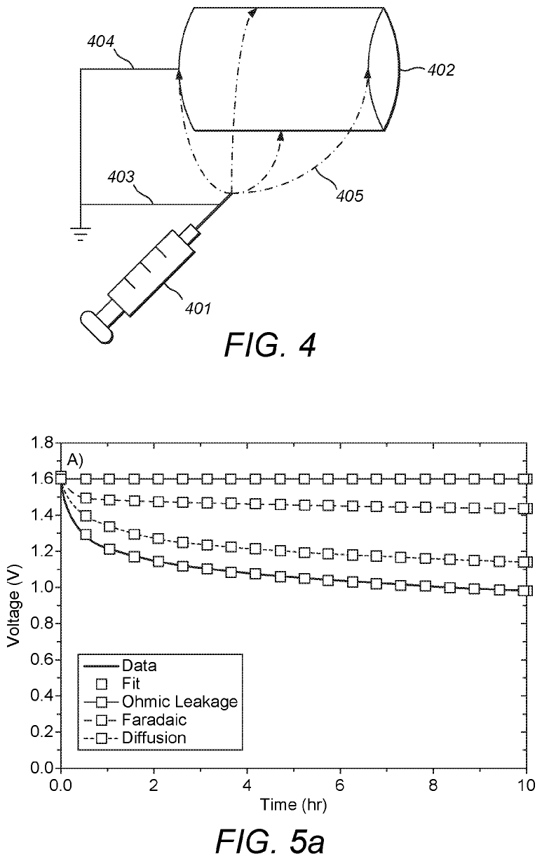

FIG. 4 illustrates an electrospinning process for forming a separator such as the one illustrated in FIG. 3. The electrospinning process involves loading a dissolved solution of a material, such as PVDF, into a spinneret 401 with a hollow needle nozzle. The spinneret 401 is then placed under an electric field, for example by applying a high voltage between the spinneret 401 and a mandrel 402 through electrical connections 403, 404. In the embodiment shown in FIG. 4, an electrical connection 403 to the spinneret 401 is connected to the positive terminal of a high voltage power source, and an electrical connection 404 to the mandrel 402 is connected to ground. This produces the electric field between the spinneret 401 and the mandrel 402.

A mechanical force is then exerted on the spinneret 401 to produce a flow of solution through the hollow needle nozzle. A charged jet will be ejected from the spinneret 401 tip when the electrostatic force overcomes the surface tension of the liquid. In flight the polymer jet forms a Taylor cone and experiences a stretching and whipping motion due to the repulsive forces between the surface charges carried before drying and landing on a collector plate of the mandrel 402. The mandrel 402 is configured to spin such that the polarised nanofibers spool around the cylindrical shape, forming thin films of long PVDF nanofibers. Fabricating the separator by electrospinning a precursor solution of a separator material in this way involves polymer stretching under a high electric field, which produces a highly polarised nanofiber film with a permanent electrical dipole.

The process may be arranged to electrospin the precursor solution such that the nanofibres are randomly oriented on the mandrel 402. Alternatively, the process may be arranged to electrospin the precursor solution such that the nanofibres are aligned on the mandrel 402. The skilled person will be familiar with the process of electrospinning, and will appreciate that the process parameters (e.g. strength and direction of applied electric field, liquid viscosity and/or temperature, rotation speed of mandrel 402, and so on) may be selected so as to produce a desired orientation of nanofibres in the film, which may be random or aligned depending on the requirements.

According to an embodiment of the present invention, the nanofibres may have a mean diameter of between 50 nm and 600 nm. Methods used to control the diameter of the resulting nanofibers may include modifying the solution viscosity, the flow rate, environmental factors such as temperature and humidity, the voltage potential between the spinneret 401 and the mandrel 402, and the separation distance between the spinneret 401 and mandrel 402.

Similarly, in general, the nanofibre film may have any suitable porosity. In some embodiments, the nanofibre film may have a mean porosity of between 75% and 85%.

As described above, using a relatively high porosity such as between 75-85% can provide a supercapacitor which has a relatively low ESR.

The precursor solution may comprise PVDF, such that when the precursor solution is ejected from the spinneret 401, it produces the material with a permanent electrical dipole comprising PVDF. The precursor solution may also comprise a surfactant, such that when the precursor solution is ejected from the spinneret 401, it produces the material with a permanent electrical dipole comprising the surfactant. The surfactant may comprise SDS. The volumetric concentration of SDS included in the precursor solution and the material with a permanent electrical dipole may be between 1% and 2%.

Alternative and/or additional methods of producing the separator comprising a material with a permanent electrical dipole include the use of thermal annealing to enhance the effect of polarising the material with a permanent electrical dipole. This involves exposing the separator material to thermal energy so as to heat the material to an increased temperature, and maintaining this temperature for an appropriate amount of time. During the time at the increased temperature, the material is exposed to an electric field. This results in an enhanced polarisation of the material.

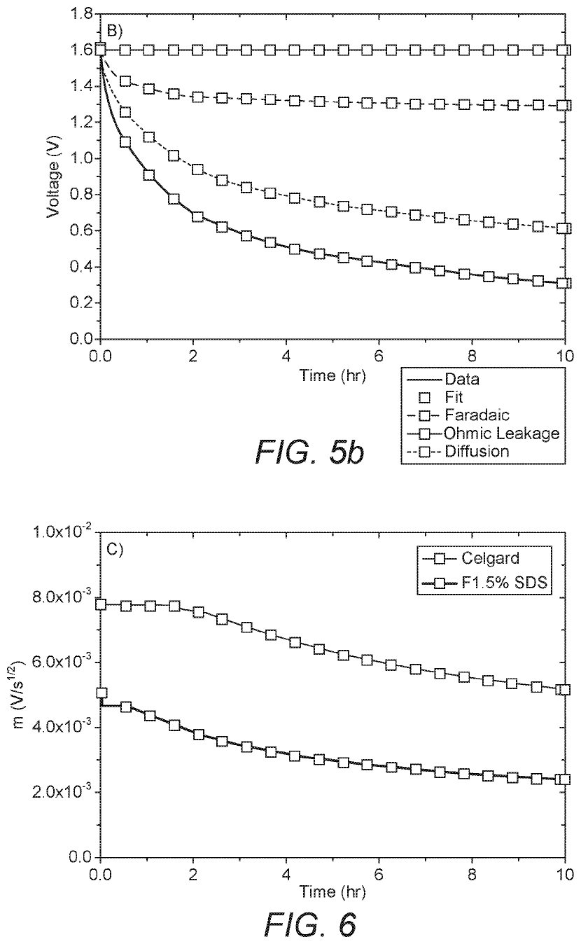

FIG. 5a is a graph showing experimental data illustrating of the self-discharge properties of the proposed supercapacitor (F1.5% SDS). FIG. 5b is a graph showing experimental data illustrating the self-discharge properties of a current supercapacitor (Celgard). The addition of ionic transport resistance between the bulk of the electrolyte and the surface of the electrolyte has a strong effect on the self-discharge properties of the supercapacitor device where FIG. 5a and FIG. 5b display the open circuit potential, OCP vs time for each device after they were charged and held at 1.6V for 1 hr to ensure full electrolyte saturation of the electrode pores.

In both devices the primary cause of self-discharge comes from the diffusion-controlled reactions followed by a small contribution from faradaic reactions and a minimal effect from Ohmic leakage, however, the self-discharge rate of the F1.5% SDS cell decreases due to a significant reduction of the diffusion contribution. As shown in FIG. 5a the F1.5% SDS cell displays a 384 mV/hr self-discharge rate for the first hour allowing 76% retention of the original. As a large proportion of the self-discharge occurs in the first hour, over 5 hours the self-discharge rate drops to 109 mV/hr and only losing a further 10% of the voltage, reducing to 66% where by this time the energy density has reduced to 44%. Over the whole 10-hour period the discharge rate relaxes to 66 mV/hr, here 59% voltage is retained, and 35% energy is preserved within the device. This is a significant improvement to Celgard where this device illustrated in FIG. 5b has a self-discharge rate of 673 mV/hr within the first hour, only retaining 58% of the voltage and 33.5% of the energy density in this period.

FIG. 6 is a graph showing experimental data illustrating the diffusion coefficient of the proposed supercapacitor and a current supercapacitor. The reduction in self-discharge rate resulting from the addition of ionic transport resistance from the F1.5% SDS separator can be further analysed by the extraction of the diffusion coefficient m, this is illustrated for each device in FIG. 6 where the diffusion coefficient is incrementally plotted vs time throughout the whole self-discharge process, here an initial recording of 7.8×10-3 V·s-½ and 4.7×10-3 V·s-½ for Celgard and F1.5% SDS respectively showing a 40% decrease in the diffusion coefficient.

The diffusion coefficient for both devices steadily declines as the OCP decays and the ions start to diffuse away from electrodes, slowly reaching an equilibrium state between the concentration of ions in the electrode pores and the bulk of the electrolyte. By the 10-hr point, the diffusion coefficients diminish to 5.2×10-3 V·s-½ and 2.4×10-3 V·s-½ for Celgard and F1.5% SDS respectively.

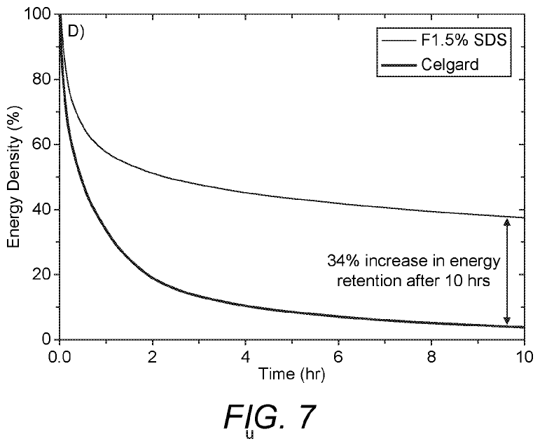

FIG. 7 is a graph showing experimental data illustrating the percentage of the starting energy density over time for the proposed supercapacitor and a current supercapacitor. This clearly shows the difference in performance between a current conventional supercapacitor (Celgrad) and the proposed supercapacitor (F1.5% SDS). The most noticeable difference occurs in the first 2 hours of the experiment, where the Celgard cell experiences approximately a reduction in energy density of 80%. However, F1.5% SDS retains approximately 50% of its energy density, a 50% reduction over the same period.

After the initial rapid fall in energy density, F1.5% SDS also outperforms the Celgrad cell as there is a 34% increase in energy retention after 10 hours.

As demonstrated, the incorporation of piezoelectric nanofiber films as an electroactive separator material in EDLC supercapacitor devices can provide effective measures to reduce the self-discharge properties of these devices. Three key mechanisms characterize the self-discharge properties of a supercapacitor, with electrolyte diffusion and redistribution being the main contributor to this behaviour. The incorporation of highly wettable SDS doped PVDF nanofiber separators with permanent dipoles present within the material provides an electric field that interacts with the electrolyte ions in the device to form an energy barrier for ionic diffusion, resulting in a 43% decrease in supercapacitor self-discharge compared to that of devices incorporating commercial level non-electroactive separator materials without the compromising the specific capacitance of the device. This new mechanism will provide increased energy storage efficiency particularly in the field of energy scavenging and harvesting, additionally, this may offer routes to longer-term energy storage applications for supercapacitor devices.

Whilst certain embodiments of the invention have been described herein with reference to the drawings, it will be understood that many variations and modifications will be possible without departing from the scope of the invention as defined in the accompanying claims.

1. A supercapacitor comprising:
a first electrode;
a second electrode;
a separator disposed between the first and second electrodes, the separator comprising a permanent electrical dipole, wherein the separator is arranged such that the permanent electrical dipole is oriented so as to present an energy barrier to inhibit a self-discharge diffusion of ions stored on the first and second electrodes while the supercapacitor is in a charged state.

2. The supercapacitor of claim 1, wherein the first and second electrodes comprise carbon.

3. The supercapacitor of claim 2, wherein the mass of the second electrode is larger than the mass of the first electrode.

4. The supercapacitor of claim 1, wherein the separator comprises a nanofibre film comprising a plurality of nanofibres.

5. The supercapacitor of claim 4, wherein the plurality of nanofibres are randomly oriented, or wherein the plurality of nanofibres are aligned.

6. (canceled)

7. The supercapacitor of claim 4, wherein the plurality of nanofibres have a mean diameter of less than or equal to 600 nm.
wherein the plurality of nanofibers have a mean diameter of more than or equal to 50 nm, and/or
wherein a mean pore size of the nanofiber film is less than 1 μm.

8-9. (canceled)

10. The supercapacitor of claim 1, wherein the separator comprises polyvinylidene fluoride, PVDF, and/or
wherein the separator comprises a surfactant.

11. (canceled)

12. The supercapacitor of claim 10, wherein the surfactant comprises sodium dodecyl sulphate, SDS.

13. The supercapacitor of claim 12, wherein a percentage by mass concentration of SDS in the separator is less than or equal to 15%, and/or
wherein a percentage by mass concentration of SDS in the separator is greater than or equal to 1%.

14. (canceled)

15. A method of fabricating a supercapacitor comprising a first electrode, a second electrode and a separator, the separator comprising a permanent electrical dipole, the method comprising:
disposing the separator between the first and second electrodes such that the permanent electrical dipole is oriented so as to present an energy barrier to inhibit a self-discharge diffusion of ions stored on the first and second electrodes while the supercapacitor is in a charged state.

16. The method of claim 15, comprising:
processing a separator material without a permanent electrical dipole so as to polarise the separator material to induce the permanent electrical dipole.

17. The method of claim 16, wherein processing the separator material comprises applying an electric field so as to polarise the separator material to induce the permanent electrical dipole.

18. The method of claim 17, wherein the electric field is applied in a direction to polarise the separator material to induce the permanent electrical dipole in said direction.

19. The method of claim 16, wherein processing the separator material comprises heating the separator material to a temperature sufficient to at least partially melt the separator material.

20. The method of claim 16, wherein the separator material comprises a polymer, and processing the separator material comprises stretching the polymer so as to polarise the separator material to induce the permanent electrical dipole.

21. The method of claim 16, wherein processing the separator material comprises incorporating a filler material that polarises the separator material to induce the permanent electrical dipole.

22. The method of claim 16, comprising:
fabricating the separator from the polarised separator material.

23. The method of claim 16, comprising:
fabricating the separator from the separator material without a permanent electrical dipole, prior to processing the separator material to induce the permanent electrical dipole.

24. The method of claim 15, comprising:
fabricating the separator by electrospinning a precursor solution of a separator material to produce a polarised nanofiber film with a permanent electrical dipole.

25. The method of claim 24, wherein a percentage by mass concentration of SDS in the separator material precursor solution is between about 1% and about 2%.
